(19) United States
(12) Patent Application Publication
(10) Pub. No.: US 2026/0307610 A1
(43) Pub. Date: Oct. 8, 2026

(54) POWER DISTRIBUTION UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Tatsuya SUMIDA, Mie (JP)

(21) Appl. No.: 19/484,354

(22) PCT Filed: May 17, 2023
(86) PCT No.: PCT/JP2023/018487

§ 371 Date: Nov. 14, 2025

(51) Int. Cl. B60R 16/03; H02G 3/03; H02G 3/08; H02G 3/16; H02H 3/087

(52) U.S. Cl. CPC B60R 16/03; H02G 3/03; H02G 3/081; H02G 3/16; H02H 3/087

(57) ABSTRACT

A main branching box of a power distribution unit includes a first power supply input portion, a plurality of main output portions, and a main branching circuit that branches the input power fed into the first power supply input portion to the plurality of main output portions. A sub-branching box of the power distribution unit includes a sub-input portion connected to one of the plurality of main output portions, a plurality of sub-output portions, and a sub-branching circuit that branches the input power fed into the sub-input portion to the plurality of sub-output portions. The main branching circuit includes a main circuit protection unit constructed by a semiconductor relay that prevents an overcurrent from flowing into the main output portion to which the sub-input portion is not connected.

### TECHNICAL FIELD

The present disclosure relates to a power distribution unit.

### BACKGROUND

Power distribution units, which are connected to a power supply, such as a battery, installed in a vehicle and distribute power supplied from the power supply to various loads are conventionally known. As one example, Patent Document 1 proposes a power distribution unit that includes a first branching box for a driving system and a second branching box for an equipment system and can reduce the number of components by making the second branching box common across different grades of vehicle.

### PRIOR ART DOCUMENT

### Patent Document

Patent Document 1: JP 2020-010462 A

### SUMMARY OF THE INVENTION

### Problems to be Solved

However, in Patent Document 1, because both the first branching box and the second branching box are equipped with fuses and the like that need to be replaced in the event of breakage, both boxes need to be installed at locations where replacement work is possible. This leaves room for improvement in terms of ease of installation in a vehicle. To address this issue, it would be conceivable to replace the fuses and other components that require replacement by constructing all of the relays, fuses, and the like using semiconductors that do not require replacement, but this would inevitably increase the physical size and cost of the circuit board on which the semiconductors are mounted, which prevents this from being a desirable solution.

For this reason, a power distribution unit that is easier to install in a vehicle while suppressing increases in physical size and cost is disclosed.

### Means to Solve the Problem

A power distribution unit according to an aspect of the present disclosure includes: a main branching box; and a sub-branching box, wherein the main branching box includes a first power supply input portion, a plurality of main output portions, and a main branching circuit that branches power inputted into the first power supply input portion to the plurality of main output portions, the sub-branching box includes a sub-input portion connected to one of the plurality of main output portions, a plurality of sub-output portions, and a sub-branching circuit that branches power inputted into the sub-input portion to the plurality of sub-output portions; the main branching circuit includes a main circuit protection unit, which is constructed by a semiconductor relay mounted on a printed circuit board and prevents an overcurrent from flowing into the main output portions aside from the main output portion to which the sub-input portion is connected, and the sub-branching circuit includes a sub-circuit protection unit constructed by a mechanical fuse that prevents an overcurrent from flowing into the sub-output portions.

### Effect of the Invention

According to this aspect of the present disclosure, it is possible to provide a power distribution unit that is easier to install in a vehicle while suppressing increases in physical size and cost.

### BRIEF DESCRIPTION OF THE DRAWINGS

FIG. 1 is a perspective view showing a power distribution unit according to a first embodiment.

FIG. 2 is a perspective view showing the power distribution unit appearing in FIG. 1 with a cover member removed.

FIG. 3 is a cross-sectional view taken along a line III-III in FIG. 2.

FIG. 4 is a perspective view of a main branching box that constructs the power distribution unit shown in FIG. 1.

FIG. 5 is a perspective view showing the main branching box appearing in FIG. 4 with an upper plate portion removed.

FIG. 6 is a plan view of the main branching box shown in FIG. 5 with the upper plate portion removed.

FIG. 7 is an exploded perspective view of the main branching box shown in FIG. 4.

FIG. 8 is a plan view of the base frame (excluding the upper plate portion) that constructs the main branching box shown in FIG. 4.

FIG. 9 is a bottom view of the base frame (excluding the upper plate portion) shown in FIG. 8.

FIG. 10 is a perspective view of a heat dissipating plate that constructs the main branching box shown in FIG. 4.

FIG. 11 is a perspective view showing a subframe in a sub branching box that constructs the power distribution unit shown in FIG. 1.

FIG. 12 is a left side view of a sub-frame shown in FIG. 11.

FIG. 13 is a circuit diagram of the power distribution unit shown in FIG. 1.

### DETAILED DESCRIPTION TO EXECUTE THE INVENTION

### Outline of Embodiments of the Present Disclosure

Several embodiments of the present disclosure will first be listed and described in outline.
(1) A power distribution unit according to an aspect of the present disclosure includes: a main branching box; and a sub-branching box, wherein the main branching box includes a first power supply input portion, a plurality of main output portions, and a main branching circuit that branches power inputted into the first power supply input portion to the plurality of main output portions, the sub-branching box includes a sub-input portion connected to one of the plurality of main output portions, a plurality of sub-output portions, and a sub-branching circuit that branches power inputted into the sub-input portion to the plurality of sub-output portions; the main branching circuit includes a main circuit protection unit, which is constructed by a semiconductor relay mounted on a printed circuit board and prevents an overcurrent from flowing into the main output portions aside from the main output portion to which the sub-input portion is connected, and the sub-branching circuit includes a sub-circuit protection unit constructed by a mechanical fuse that prevents an overcurrent from flowing into the sub-output portions.

According to the power distribution unit of the present disclosure, the distribution of power to be performed by the power distribution unit is divided between a main branching box and a sub-branching box. In the main branching box, a main circuit protection unit, which is provided in a main branch circuit to protect auxiliary equipment connected to the main output portions from overcurrents, is composed of a semiconductor relay mounted on a printed circuit board. This eliminates the need for replacement work when a fuse breaks, as happens when a circuit protection unit is constructed using mechanical fuses or the like with fusing portions, and reduces the need to install the main branching box at a location where replacement work is possible. In addition, the sub-branching box includes a sub-circuit protection unit constructed using a mechanical fuse, and the sub-input portion is connected to the main output portion of the main branching box. As one example, by connecting the main output portion and the sub-input portion with a wire harness, it is possible, even when the installed position of the sub-branching box is limited to locations where replacement work can be performed, to eliminate or reduce the impact of such restriction on the main branching box. Accordingly, it is possible to provide a power distribution unit with a greater range of freedom regarding installation in a vehicle.

In addition, in the sub-branching box, because the sub-circuit protection unit is constructed using a mechanical fuse, compared to when the circuit protection units of the entire power distribution unit are constructed using semiconductor relays, it is possible to suppress increases in the physical size and cost of the power distribution unit.

Vehicle safety can also be improved by connecting loads related to vehicle safety, such as the vehicle's braking system, steering system, and driving control system, to the plurality of main output portions of the main branching box, whose circuit protection unit is constructed of semiconductor relays with low failure rates. If loads related to comfort in the vehicle, such as air conditioning and audio, are connected to the sub-branching box, it is possible to improve vehicle safety and to facilitate the addition of or changes to loads related to vehicle comfort as needed, which facilitates maintenance on the vehicle.
(2) In the power distribution unit according to (1) above, it is preferable for the main branching box to include a second power supply input portion to which a second power supply, which differs from the first power supply connected to the first power supply input portion, is connected, for the main branching circuit to include semiconductor switches that are mounted on the printed circuit board and separately connect the first power supply input portion and the second power supply input portion to a circuit on the main output portion side, and when an abnormality occurs for one out of the first power supply and the second power supply, for the first power supply input portion or the second power supply input portion connected to another out of the first power supply or the second power supply to be connected by the semiconductor switches to the circuit on the main output portion side.

The main branching box includes the first power supply input portion and the second power supply input portion which are each connected to a different power supply. If an abnormality occurs at either power supply, the other power supply, which is not malfunctioning, is connected to a circuit on the main output portion side by a semiconductor switch in the main branching circuit. With this configuration, the supplying of power to the main output portion side is stabilized, which further improves vehicle safety.
(3) In the power distribution unit according to (1) or (2) above, it is preferable for the main branching box to include a heat dissipating plate which is in thermal contact, via an electrically-insulating thermally-conductive member, with an opposite surface of the printed circuit board to a surface on which the semiconductor relay is mounted. Devices such as semiconductor relays mounted on a printed circuit board generate a large amount of heat, making it important to ensure favorable dissipation of heat to stabilize operations. Through thermal contact between the opposite surface of the printed circuit board to the mounting surface of the semiconductor relays and a heat dissipating plate via the electrically-insulating thermally-conductive material, a heat dissipation path with a wide contact area can be achieved with favorable space efficiency from the printed circuit board to the heat dissipating plate.
(4) In the power distribution unit according to (3) above, it is preferable for the main branching box to include a base frame including a bottom plate portion on which the printed circuit board is placed, and a peripheral wall portion that protrudes from a peripheral edge of the bottom plate portion and surrounds a periphery of the printed circuit board, for an opposite surface of the bottom plate portion of the base frame to the surface on which the printed circuit board is placed to form a contact surface that contacts the heat dissipating plate, for the bottom plate portion to include an outer periphery support portion, which extends continuously around a circumference of the printed circuit board and on which a peripheral edge of the printed circuit board is placed, and a through window, which passes in the plate thickness direction through an area closer to an inside than the outer periphery support portion, for the contact surface of the outer periphery support portion to be provided with an annular protrusion that protrudes toward the heat dissipating plate and extends continuously around a circumference of the outer periphery support portion, for a surface of the heat dissipating plate that faces the base frame to be provided with an annular channel, which is recessed in an annular shape and into which the annular protrusion is inserted, and in a state where the bottom plate portion of the base frame has been placed on the heat dissipating plate, the annular protrusion has been inserted into the annular channel, and the opposite surface of the printed circuit board exposed through the through window has contacted the heat dissipating plate via the electrically-insulating thermally-conductive member, for an internal region of the base frame surrounded by the peripheral wall portion and the bottom plate portion to be filled with a resin material.

The printed circuit board is placed on the base frame, and the peripheral edge of the printed circuit board is placed on the annular outer periphery support portion of the base frame, so that the printed circuit board is stably held by the base frame. In addition, the annular protrusion on the contact surface of the outer periphery support portion of the base frame is inserted into the annular channel formed in the surface of the heat dissipating plate that faces the base frame, which makes it possible to align and join the base frame to the heat dissipating plate. Here, a through window is provided in the bottom plate portion of the base frame, and the printed circuit board exposed from this through window contacts the heat dissipating plate without the bottom plate portion in between, which improves the heat dissipation performance of the main branching box.

The main branching box is often located near a battery installed in the engine compartment, and often needs to be waterproof. For this reason, the base frame has a peripheral wall portion that protrudes from the peripheral edge of the bottom plate portion and surrounds the printed circuit board, and because an internal area surrounded by the peripheral wall portion and bottom plate portion is filled with a resin material, it is possible to advantageously ensure that the printed circuit board disposed in the internal area of the base frame and components mounted on the printed circuit board are waterproof with a simple structure. Although a through window is provided in the bottom plate portion of the base frame, such through window is covered by the printed circuit board, and even if the resin material filled in the internal area leaks out through the through window, further leakage to the outside can be advantageously suppressed or prevented by inserting the annular protrusion into the annular channel.

Note that so long as each through window passes through, in the plate thickness direction, an area that is more inward than the outer periphery support portion, one or a plurality of through windows may be provided to pass through the bottom plate portion at locations that are spaced apart.
(5) In the power distribution unit according to (4) above, it is preferable for the bottom plate portion to include a plurality of the through-windows that are spaced apart, for parts of the bottom plate portion remaining between the through-windows to connect facing edge portions of the outer periphery support portion to form a center support portion on which a center part of the printed circuit board is placed, for the contact surface of the center support portion to have a center protrusion that protrudes toward the heat dissipating plate, and for the center protrusion to be inserted into a center channel formed as an opening at a position on a base frame-side surface of the heat dissipating plate that faces the center protrusion.

Because the center support portion is provided using a position on the bottom plate portion that remains between the plurality of through windows, it is possible to stably hold the center part of the printed circuit board and prevent deformation and the like of the base frame. In addition, because the center protrusion on the center support portion is inserted into a center channel formed at a corresponding position on the heat dissipating plate, the bottom plate portion and the heat dissipating plate can be reliably positioned and stably assembled. Because the plurality of through windows are separated from one another by the center support portion, heat transfer between the through windows is suppressed.
(6) In the power distribution unit according to (4) above when depending on (2), it is preferable for the base frame to be positioned facing the bottom plate portion with a gap in between and to be shaped as a rectangular box including an upper plate portion that covers an opening at a protruding end of the peripheral wall portion, for the first power supply input portion and the second power supply input portion, which are bolt-shaped, to be provided at both ends in a width direction of a first side wall that constructs the peripheral wall portion, for both end regions in a width direction of the upper plate portion adjacent to the first side wall to form a pair of routing regions in which wire harnesses, on which crimped terminals fastened to the first power supply input portion and the second power supply input portion have been crimped, are routed, and for the sub-branching box to be positioned in a center part in the width direction of the upper plate portion between the pair of routing regions.

The sub-branching box can be installed using a space on the upper plate portion side of the base frame, which is on the opposite side to the heat dissipating plate. In addition, by using both sides of the sub-branching box as routing areas for wire harnesses that extend from the crimped terminals fastened to the first power supply input portion and the second power supply input portion, it is possible to use the height by which the sub-branching box protrudes from the upper plate portion to route the wire harnesses for supplying power between the main branching box and sub-branching box with favorable space efficiency. By doing so, it is possible to reduce the installation space required by the power distribution unit as a whole.

### Detailed Description of Embodiments of the Present Disclosure

Preferred embodiments of a power distribution unit according to the present disclosure will now be described with reference to the drawings. Note that the present disclosure is not limited to the embodiments given here, is indicated by the range of the patent claims, and is intended to include all possible changes and modifications within the meaning and scope of the patent claims and their equivalents.

### First Embodiment

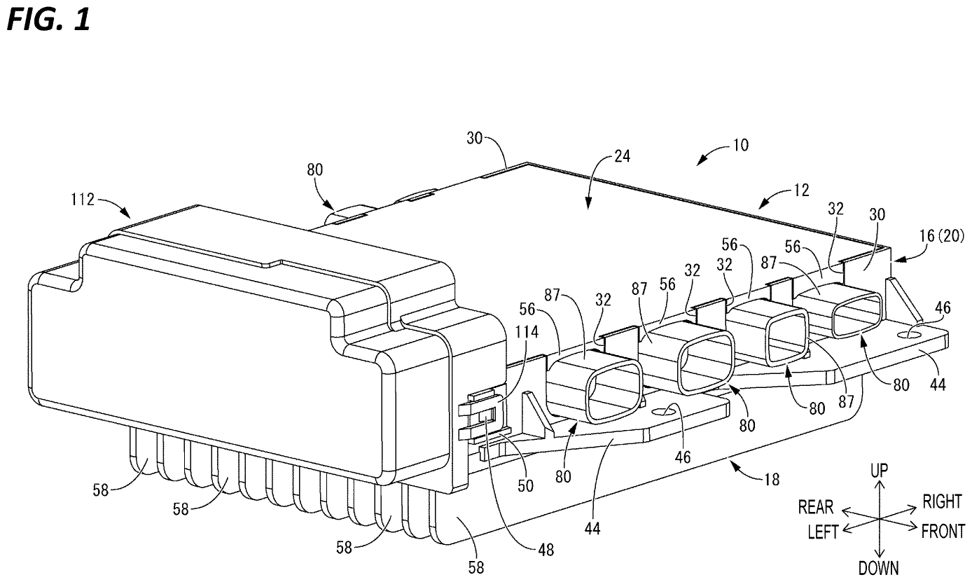

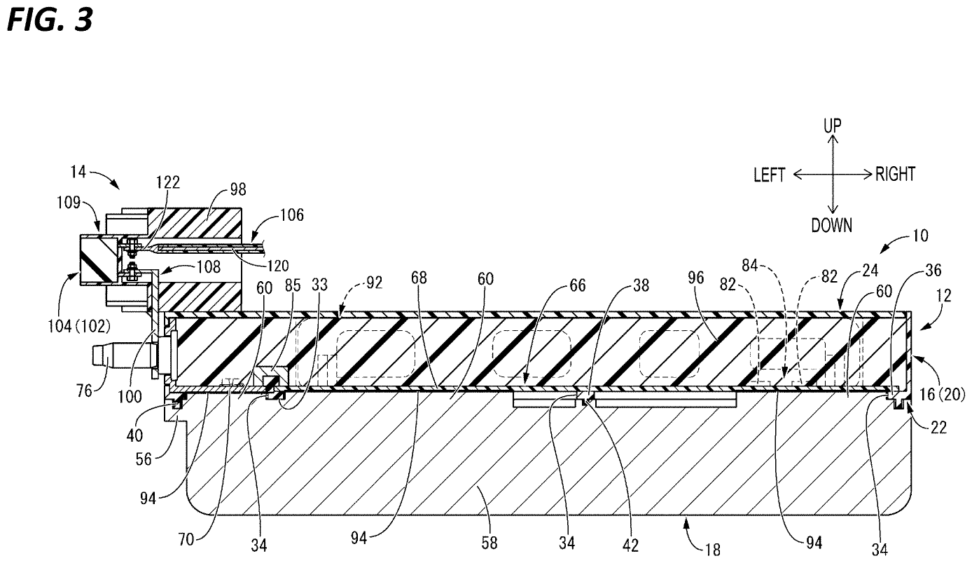

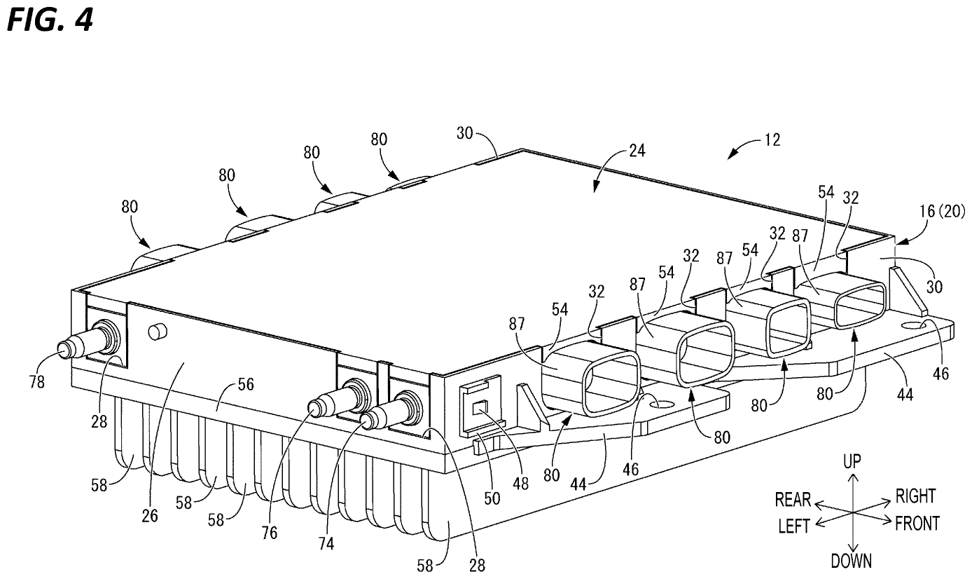

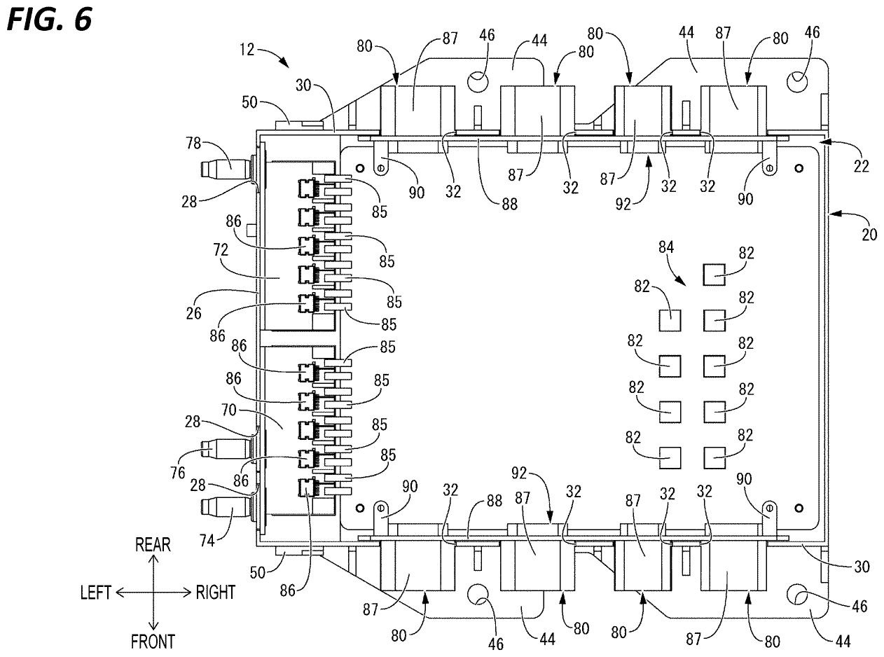

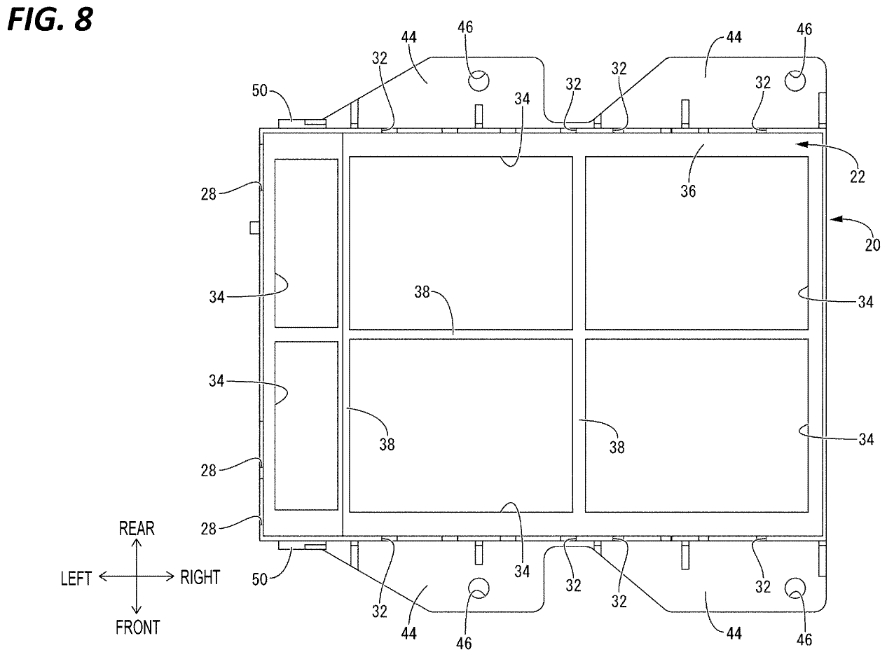

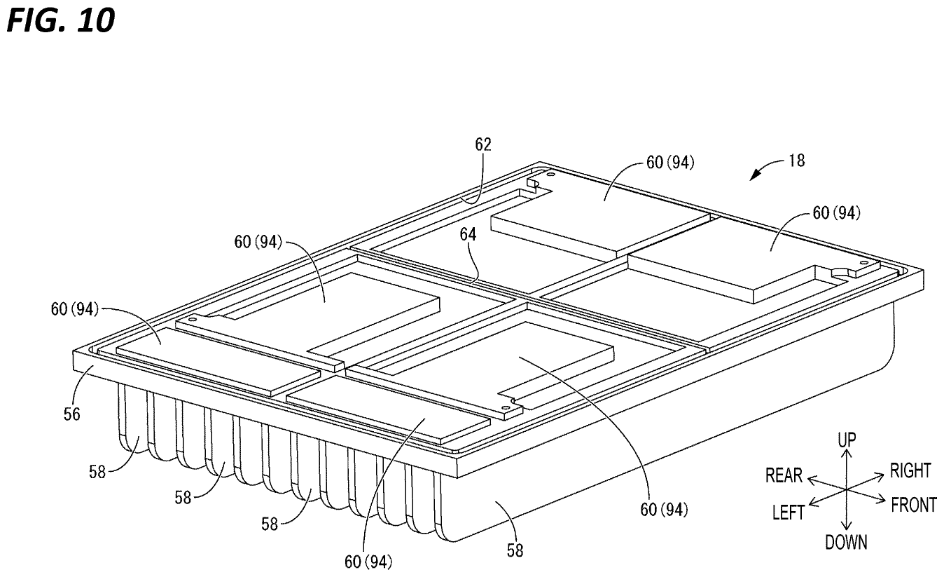

A power distribution unit 10 according to a first embodiment of the present disclosure will be described below with reference to FIGS. 1 to 13. The power distribution unit 10 is equipped with a main branching box 12 and a sub-branching box 14. Note that although the power distribution unit 10 can be placed in any orientation, in the following description, the expression “up” refers to the upper side in FIG. 1, “down” refers to the lower side in FIG. 1, “left” refers to the left side in FIG. 3, “right” refers to the right side in FIG. 3, and the “front-rear direction” is a direction perpendicular to the plane of FIG. 3. In a case where a plurality of components are the same, reference numerals may be assigned to only some of such components and the reference numerals may be omitted for other components.

### Main Branching Box 12

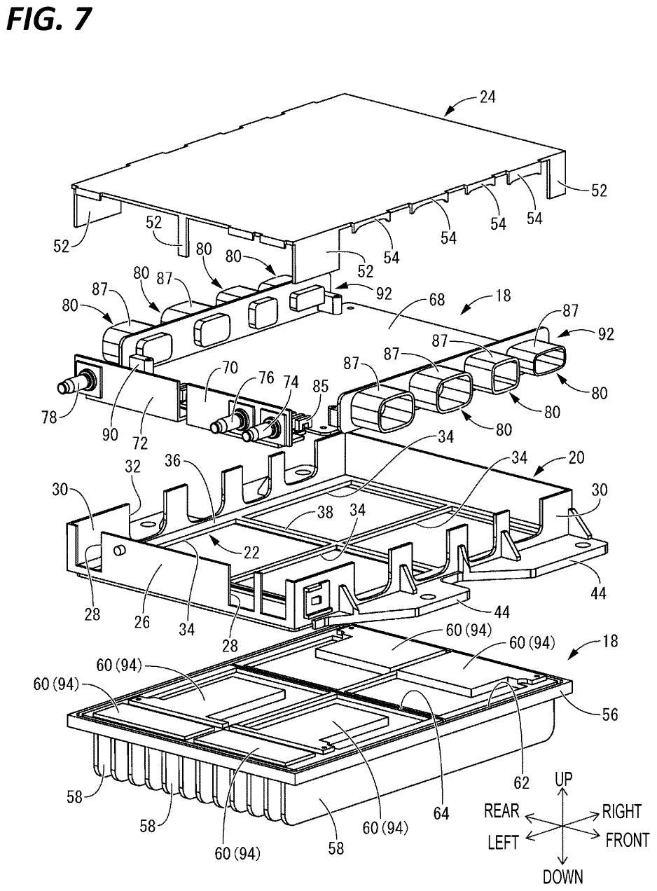

The main branching box 12 distributes power inputted from a first power supply 117 and a second power supply 119, described later, to a plurality of primary loads 124, also described later. As shown in FIG. 7, the main branching box 12 includes a base frame 16 and a heat dissipating plate 18.

### Base Frame 16

The base frame 16 is in the overall shape of a hollow rectangular parallelepiped and includes a peripheral wall portion 20, a bottom plate portion 22, and an upper plate portion 24. The peripheral wall portion 20 rises upward from a peripheral edge of the bottom plate portion 22, which is rectangular, and is integrally formed with the bottom plate portion 22. A first side wall 26, which is the left-side part of the peripheral wall portion 20, has two terminal insertion holes 28, 28, which pass through in a perpendicular direction, at a front-end part of the first side wall 26 and one terminal insertion hole 28, which passes through in the perpendicular direction, at a rear-end part of the first side wall 26. These terminal insertion holes 28 in the first side wall 26 are open to above. A plurality of (in the present embodiment, four) connector insertion holes 32 are formed in second side walls 30, 30, which are the front and rear facing parts of the peripheral wall portion 20. The connector insertion holes 32 are formed so as to pass through the second side walls 30 in the perpendicular direction and are open to above.

The bottom plate portion 22 is shaped like a flat plate that extends in directions substantially perpendicular to the vertical direction, with its upper surface serving as a support surface that is brought together with a printed circuit board 68, described later, and its lower surface serving as a contact surface 33 that is brought together with the heat dissipating plate 18. The bottom plate portion 22 is provided with a plurality of through windows 34 that pass through in the vertical direction, which is the thickness direction. The through windows 34 are rectangular holes and are formed in an inner peripheral part of the bottom plate portion 22, with an outer periphery support portion 36, which is in the form of a rectangular frame-shape that is continuous in the circumferential direction, formed in the outer periphery of the through windows 34. In other words, the through windows 34 are formed to pass in the thickness direction through an area of the bottom plate portion 22 that is more inward than the outer periphery support portion 36.

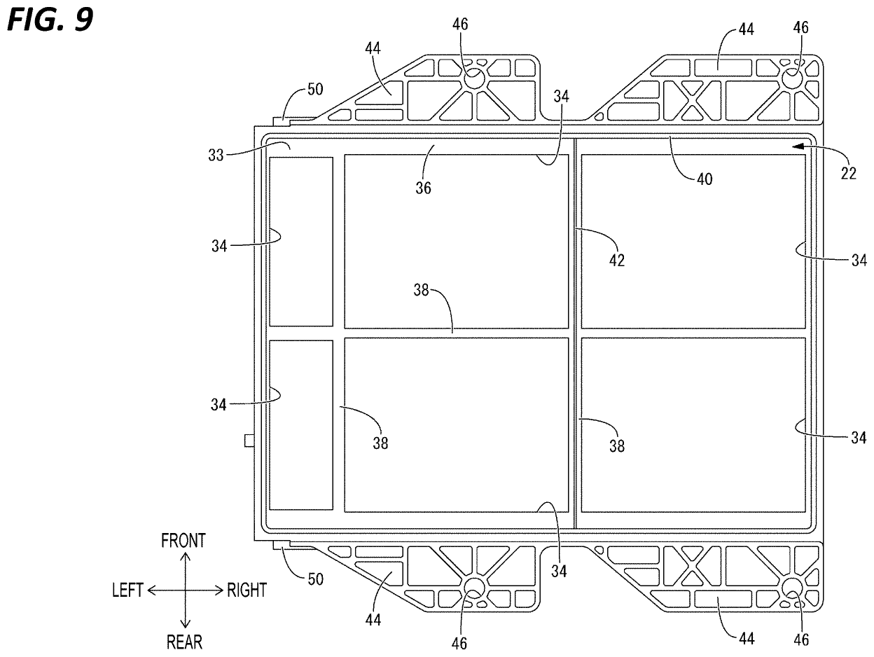

The plurality of through windows 34 are spaced apart in the front-to-rear and left-to-right directions, and the bottom plate portion 22 remaining between the through windows 34 extends linearly in the front-to-rear or left-to-right directions to form center support portions 38 that interconnect opposing sides of the outer periphery support portion 36 in the front-to-rear or left-to-right directions. As shown in FIG. 9, the outer periphery support portion 36 has an annular protrusion 40 that protrudes from part of a contact surface 33, which is the lower surface, continuously around the entire circumference. A center support portion 38 that extends in the front-to-rear direction is also provided with a center protrusion 42 that extends linearly in the front-rear direction and protrudes downward. Although the annular protrusion 40 and the center protrusion 42 extend with a substantially constant cross-section in the present embodiment, the cross-sectional shape and/or size may vary, and/or the protrusions may extend in a zigzag or serpentine pattern.

Leg portions 44 for attachment to a vehicle body or the like, not illustrated, are integrally formed on the base frame 16. The leg portions 44 are plate-shaped and extend perpendicular to the vertical direction, and protrude outward in the front and rear directions from a lower end of the peripheral wall portion 20. Bolt holes 46 for fixing to the vehicle body are formed to pass through the leg portions 44 in the vertical direction.

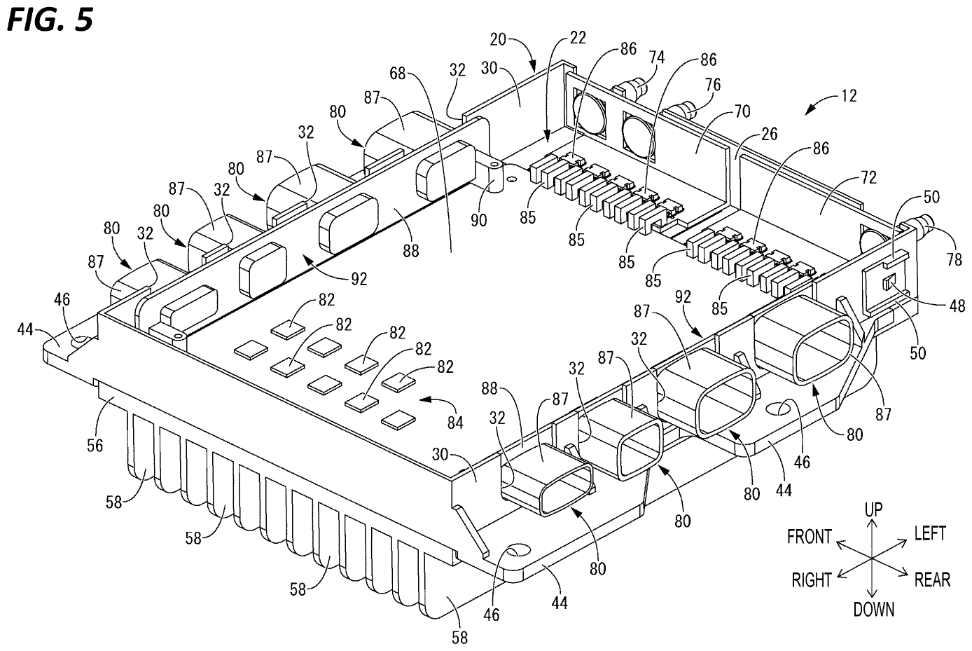

Engagement protrusions 48, which are engaged by a cover member 112, described later, are provided at left-end parts of the peripheral wall portion 20 that face each other in the front-rear direction. As shown in FIG. 5, the overall shape of each engagement protrusion 48 is an approximately right-angled triangular prism whose left side is an inclined surface, and protrude outward in the front-rear direction from the peripheral wall portion 20. Guide portions 50 that extend in the left-right direction are provided on both the upper and lower sides of each engagement protrusion 48.

The upper plate portion 24 is shaped as an approximately rectangular plate, and is provided with positioning pieces 52 that extend downward at a plurality of locations including the four corners. Insertion portions 54, which are inserted into the insertion holes 28, 32 of the peripheral wall portion 20, are integrally formed with the upper plate portion 24. The upper plate portion 24 is fitted into an upper opening of the peripheral wall portion 20 and is positioned facing the bottom plate portion 22 at a distance above the bottom plate portion 22, thereby forming the base frame 16 in the shape of a hollow box. The upper plate portion 24 is positioned relative to the peripheral wall portion 20 and the bottom plate portion 22 in an axially-perpendicular direction by inserting the positioning pieces 52 into the inner periphery of the peripheral wall portion 20.

### Heat Dissipating Plate 18

The heat dissipating plate 18 includes a contact plate portion 56 that is placed on the contact surface 33 of the bottom plate portion 22 of the base frame 16, and a plurality of heat dissipating fins 58 that protrude downward from the contact plate portion 56. The heat dissipating plate 18 is preferably made of a material with high thermal conductivity, such as a metal like aluminum alloy, copper alloy, or stainless steel. With consideration to the balance between thermal conductivity, weight, rigidity, and other factors, the heat dissipating plate 18 in the present embodiment is made of aluminum alloy. A plurality of board contact portions 60, which correspond to the plurality of through windows 34 formed in the bottom plate portion 22 of the base frame 16, protrude from the upper surface of the contact plate portion 56. An annular channel 62, into which the annular protrusion 40 of the base frame 16 can be inserted, is also formed in an outer peripheral part of the contact plate portion 56 as an opening in an upper surface, which is the surface placed on the base frame 16. In addition, a center channel 64, which is an opening in an upper surface and into which the center protrusion 42 of the base frame 16 can be inserted, is formed in a center part in the left-right direction of the contact plate portion 56. The heat dissipating fins 58 are plate-shaped, and a plurality of fins are provided in parallel and spaced apart in the front-rear direction.

The heat dissipating plate 18 is attached to the bottom plate portion 22 of the base frame 16 by placing the contact plate portion 56 from below onto the bottom plate portion 22. The annular protrusion 40 of the bottom plate portion 22 is inserted into the annular channel 62 of the contact plate portion 56, and the center protrusion 42 of the bottom plate portion 22 is inserted into the center channel 64 of the contact plate portion 56, which positions the bottom plate portion 22 and the contact plate portion 56 relative to each other in directions perpendicular to the vertical direction, thereby facilitating this attachment task. The board contact portions 60 of the contact plate portion 56 are inserted into the through windows 34 that pass through the bottom plate portion 22, and are exposed to above without being covered by the bottom plate portion 22. Note that the base frame 16 and the heat dissipating plate 18 are fixed to each other by various known fixing means, such as adhesive, welding, bolting, or mechanical engagement.

### Main Branching Circuit 66

The main branching box 12 also includes a main branching circuit 66. In the present embodiment, the main branching circuit 66 is configured as an electrical circuit mounted on the surface of the printed circuit board 68. The main branching circuit 66 is electrically connected to: a first bus bar 70 and a second bus bar 72, a first input bolt 74 as a first power supply input portion electrically connected to the first bus bar 70; an output bolt 76 as a main output portion electrically connected to the first bus bar 70; a second input bolt 78 as a second power supply input portion electrically connected to the second bus bar 72; and a plurality of connectors 80 as main output portions connected to an electrical circuit on the printed circuit board 68. With this configuration, the first input bolt 74 and the second input bolt 78 are electrically connected to the output bolt 76 by the main branching circuit 66, and the power supplied to the first and second input bolts 74 and 78 is distributed by the main branching circuit 66 to the output bolt 76 and the plurality of connectors 80.

### Printed Circuit Board 68

The printed circuit board 68 includes printed wiring for an electrical circuit (not illustrated) that electrically connects the first input bolt 74, which is the first power supply input portion, and second input bolt 78 to the output bolt 76, which is the main output portion, and the connectors 80. Semiconductor relays 82 are also mounted on the printed circuit board 68. The semiconductor relays 82 are composed of semiconductor chips and switch between connecting and disconnecting electrical circuits to prevent an overcurrent from flowing into a plurality of connectors 80 to which devices aside from a bus bar 100 (the primary loads 124, described later) are connected, thereby constructing a main circuit protection unit 84 of the present embodiment. There are no limits on the number of semiconductor relays 82 and their layout on the printed circuit board 68. As examples, the supplying of power to the plurality of connectors 80 may be switched collectively or the supplying of power to the connectors 80 may be switched individually.

### First Bus Bar 70, First Input Bolt 74, and Output Bolt 76

The first bus bar 70 is made of an electrically conductive material, such as metal, is L-shaped in cross section, and extends linearly in the front-rear direction. The first input bolt 74 and the output bolt 76 are embedded in a part that protrudes upward. The first input bolt 74 and the output bolt 76 are both bolt-shaped, are composed of stud bolts made of an electrically conductive material, and protrude forward by passing through the first bus bar 70. The parts of the first bus bar 70 surrounding the first input bolt 74 and the output bolt 76 also protrude further forward than other parts. The first input bolt 74 and the output bolt 76 are electrically connected to the first bus bar 70. The first input bolt 74 and the output bolt 76 may have threads formed on their shaft portions so that nuts can be screwed onto the bolts.

### Second Bus Bar 72 and Second Input Bolt 78

The second bus bar 72 is made of an electrically conductive material, such as metal, is L-shaped in cross section, and extends linearly in the front-rear direction. The second input bolt 78 is attached to a part of the second bus bar 72 that protrudes upward. The second input bolt 78 is bolt-shaped, is composed of a stud bolt made of an electrically conductive material, and protrudes forward by passing through the second bus bar 72. A part of the second bus bar 72 surrounding the second input bolt 78 protrudes further forward than other parts. The second input bolt 78 and the second bus bar 72 are electrically connected. Like the first input bolt 74, the second input bolt 78 may have a thread formed on its shaft. Note that the first bus bar 70 and the second bus bar 72 are electrically connected to an electrical circuit on the printed circuit board 68 by a plurality of jump bus bars 85, for example. In the present embodiment, field-effect transistors (FETs) 86 are connected to the first and second bus bars 70 and 72, respectively.

Each connector 80 is equipped with connector pins (not illustrated), which are electrically connected to the electrical circuit of the printed circuit board 68, and a hood 87, which is made of resin and surrounds the connector pins. The plurality of connectors 80 are arranged in a straight line and separated from one another in the left-right direction, and the hoods 87 of the connectors 80 are integrally connected via a connector plate portion 88. The connector plate portion 88 protrudes outward from the hoods 87 in the form of a flange. Fixing portions 90 that protrude inward in the front-rear direction are integrally formed at both the left and right ends of the connector plate portion 88, and the connectors 80 are attached to the printed circuit board 68 by fastening such fixing portions 90 to the printed circuit board 68 by screwing or other means. In the present embodiment, four connectors 80 are integrally provided by the connector plate portion 88 to form a connector unit 92, and by fixing one connector plate portion 88 to the printed circuit board 68, four connectors 80 can be positioned relative to the printed circuit board 68, which facilitates the task of attaching the connectors 80 to the printed circuit board 68. In the present embodiment, two connector units 92 are provided and are attached to the front and rear ends of the printed circuit board 68.

The printed circuit board 68 equipped with the main branching circuit 66 is attached to the base frame 16. In more detail, the printed circuit board 68, to which the first and second bus bars 70, 72 and the connector units 92, 92 have been attached, is inserted into the inner periphery of the peripheral wall portion 20 of the base frame 16, becomes surrounded by the peripheral wall portion 20, and is supported by being placed on the upper surface of the bottom plate portion 22 of the base frame 16. In the present embodiment, outer peripheral edges of the printed circuit board 68 are supported by being placed on the outer periphery support portion 36 of the bottom plate portion 22 and a center part of the printed circuit board 68 is supported by being placed on the center support portions 38 of the bottom plate portion 22. In this way, the printed circuit board 68 is supported by the bottom plate portion 22 not only at its outer peripheral edges but also at the center part, which enables the printed circuit board 68 to be stably supported. The printed circuit board 68 also reinforces the bottom plate portion 22, whose rigidity against deformation is reduced by the formation of the through windows 34, and thereby prevents deformation and the like of the bottom plate portion 22.

At parts of the printed circuit board 68 located above the through windows 34 in the bottom plate portion 22, a lower surface of the printed circuit board 68, which is opposite the mounting surface of the semiconductor relays 82, becomes placed directly on the board contact portions 60 of the heat dissipating plate 18 without the bottom plate portion 22 of the base frame in between. With this configuration, the efficiency of heat transfer from the printed circuit board 68 to the heat dissipating plate 18 is increased compared to when the bottom plate portion 22 is placed in between, which enables the printed circuit board 68 to be cooled more efficiently.

As shown in FIG. 3, an electrically-insulating thermally-conductive member 94 is interposed between the combined surfaces of the printed circuit board 68 and the board contact portions 60. The electrically-insulating thermally-conductive member 94 is formed of a material that is electrically insulating and has high thermal conductivity. As examples, the electrically-insulating thermally-conductive member 94 may be a sheet that has silicone, polyamide, or epoxy resin as a main component, or may be adhesive with high thermal conductivity. By providing the electrically-insulating thermally-conductive member 94, any gaps between the combined surfaces of the printed circuit board 68 and the board contact portions 60 of the heat dissipating plate 18 become filled with the electrically-insulating thermally-conductive member 94, so that heat is efficiently transferred from the printed circuit board 68 to the heat dissipating plate 18, which improves the heat dissipation performance.

The first and second bus bars 70, 72 connected to the printed circuit board 68 are placed on an inner surface of the first side wall 26 of the peripheral wall portion 20 of the base frame 16. The first input bolt 74 and the output bolt 76 attached to the first bus bar 70 are inserted through the terminal insertion holes 28, 28 formed in the front-end part of the first side wall 26 and protrude leftward beyond the first side wall 26. In the same way, the second input bolt 78 attached to the second bus bar 72 is inserted through the terminal insertion hole 28 formed in the rear-end part of the first side wall 26 and protrudes leftward beyond the first side wall 26.

The connector units 92, 92 connected to the printed circuit board 68 include the connector plate portions 88 that are placed on the inner surfaces of the second side walls 30 of the peripheral wall portion 20 of the base frame 16. The plurality of connectors 80 of the connector units 92, 92 are inserted through the connector insertion holes 32 formed in the pair of second side walls 30, 30 so as to protrude outward in the front-rear direction beyond the second side walls 30, 30.

In a state where the printed circuit board 68 has been attached to a lower part of the base frame 16 composed of the peripheral wall portion 20 and the bottom plate portion 22, the upper plate portion 24 is then attached to the peripheral wall portion 20, so that the main branching circuit 66 is housed inside the base frame 16 and the first and second input bolts 74, 78, the output bolt 76, and the connectors 80 are provided so as to be exposed from the base frame 16 to the outer periphery.

In the present embodiment, an internal region of the base frame 16 surrounded by the peripheral wall portion 20, the bottom plate portion 22, and the upper plate portion 24 is filled with a filler 96 made of an electrically insulating resin material. With this configuration, it is possible, with a simple structure, to prevent rainwater and the like from infiltrating into an internal region of the base frame 16 that houses the printed circuit board 68. Note that the filler 96 is filled into the internal region of the base frame 16 by potting, for example. During potting, the filler 96 in the form of a viscous fluid injected into the internal region of the base frame 16 is prevented from leaking to the outer periphery through the terminal insertion holes 28 and the connector insertion holes 32 by the first and second bus bars 70, 72 and the connector plate portions 88, 88. Even if filler 96 that has flowed around the outer periphery of the printed circuit board 68 leaks downward out of the through windows 34, the labyrinth structure formed by inserting the annular protrusion 40 into the annular channel 62 prevents leakage to the outer periphery.

### Sub-Branching Box 14

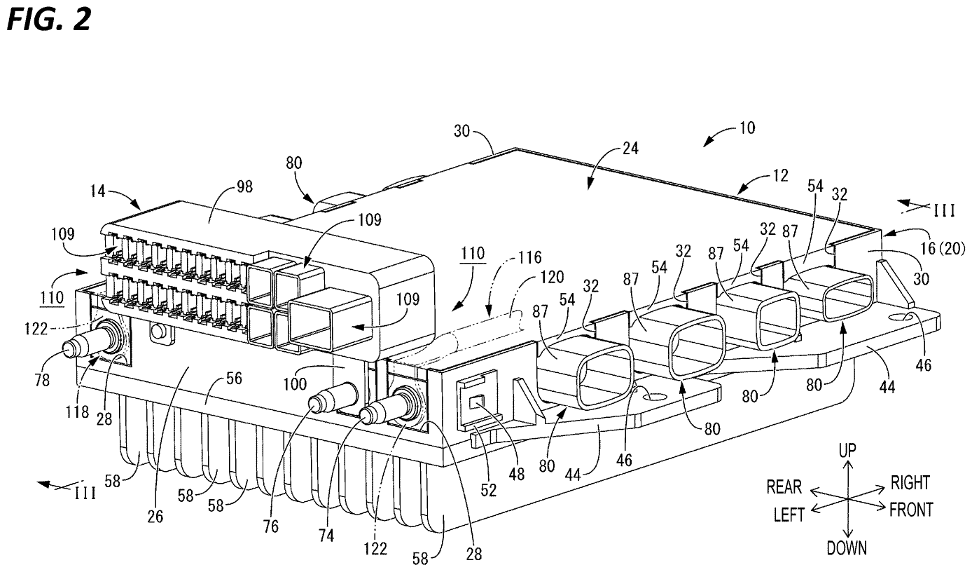

As shown in FIG. 3, the sub-branching box 14 is constructed with a sub-branching circuit 108, which includes a bus bar 100 and a plurality of mechanical fuses 102 that are connected to the bus bar 100, housed inside a hollow subframe 98. Output wires 106 are connected to the mechanical fuses 102 that construct the sub-branching circuit 108, and an end of the bus bar 100 (which serves as a sub-input portion) is connected via the sub-branching circuit 108 to the output wires 106 (which serve as a sub-output portion). The power inputted into the bus bar 100 is distributed to the plurality of output wires 106 by the sub-branching circuit 108. Note that the mechanical fuses 102 in the sub-branching box 14 are not shown in FIG. 2.

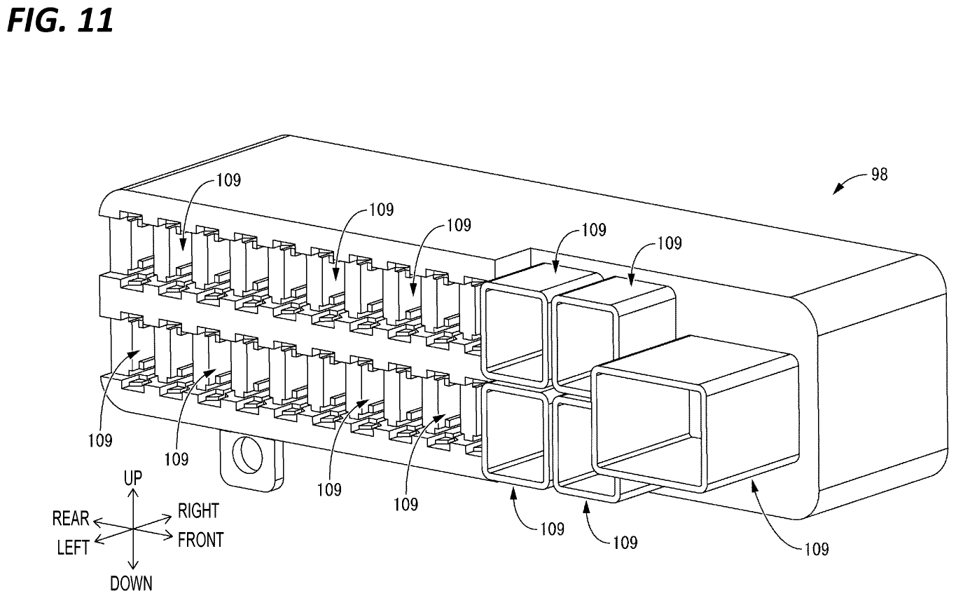

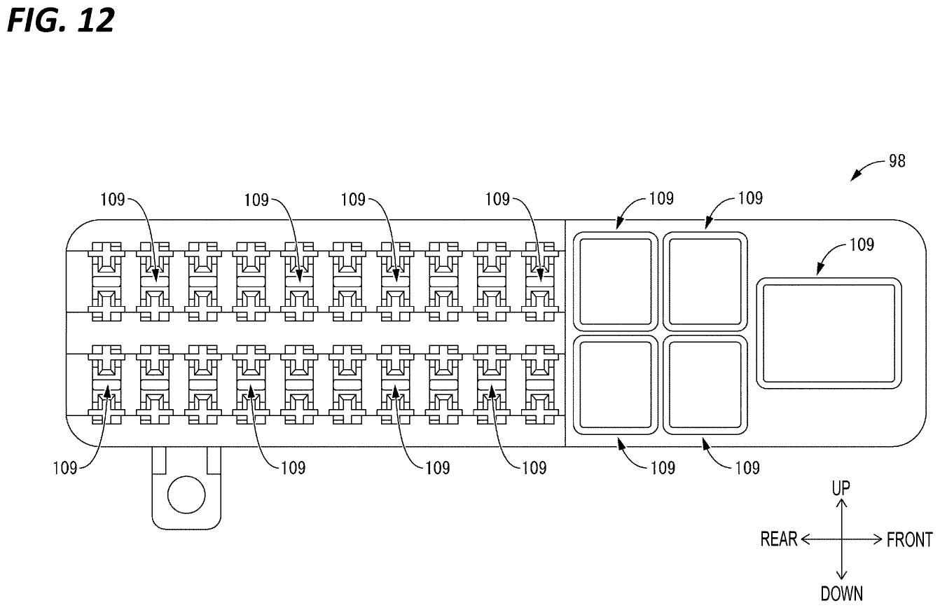

The subframe 98 is shaped like a hollow box with an opening to the right and is provided with a plurality of fuse placement portions 109 that are open to the left. The mechanical fuses 102 in the sub-branching circuit 108 are placed in these fuse placement portions 109 of the subframe 98. The mechanical fuses 102 have fuse portions that melt when an overcurrent flows to cut off the circuit, which prevents an overcurrent from flowing into the output wires 106, and thereby construct a sub-circuit protection unit 104. The mechanical fuses 102 include high-voltage fusible links. In the present embodiment, a high-voltage mechanical fuse, a medium-voltage mechanical fuse, and a low-voltage mechanical fuse are used as the mechanical fuses 102. Note that as can be understood from the fuse placement portions 109 in FIGS. 11 and 12, a plurality of mechanical fuses 102 of different voltages, sizes, shapes, structures, and the like are provided, with it being possible to use mechanical fuses of known constructions for any of such fuses.

As shown in FIGS. 1 to 3, the sub-branching box 14 includes a subframe 98 that is placed on the upper surface of the left end of the base frame 16 of the main branching box 12. The subframe 98 has a shorter length dimension in the front-rear direction than the base frame 16, and the main branching box 12 protrudes outward to both the front and rear from the sub-branching box 14. With this configuration, as shown in FIG. 2, routing areas 110, which are surrounded by the front and rear side surfaces of the subframe 98 and the upper surface of the upper plate portion 24 of the base frame 16, are formed outside both the front and rear ends of the sub-branching box 14. In other words, the sub-branching box 14 is disposed between a pair of routing areas 110, 110 provided in the areas above both front and rear end parts of the upper plate portion 24. In addition, one end of the bus bar 100 is connected to the output bolt 76 of the main branching box 12 and distributes the power outputted from the output bolt 76 to the plurality of mechanical fuses 102 in the sub-branching box 14.

### Cover Member 112

As shown in FIG. 1, a cover member 112 is attached to the main branching box 12 and the sub-branching box 14. The cover member 112 is made of synthetic resin, is in the form of a bottomed cylinder, and is provided so as to cover the left sides of the base frame 16 of the main branching box 12 and the subframe 98 of the sub-branching box 14. The cover member 112 is provided with frame-shaped engagement portions 114 at both front and rear ends, and is detachably attached to the base frame 16 by the engagement portions 114 engaging the engagement protrusions 48 of the base frame 16 in the left-right direction. The cover member 112 covers the first and second input bolts 74, 78 and the output bolt 76 of the main branching box 12 that are exposed to the outside from the base frame 16 and the mechanical fuses 102 of the sub-branching box 14 that are exposed to the outside from the subframe 98. In this way, by covering the terminal parts exposed to the outside of the main branching circuit 66 and the sub-branching circuit 108 with the cover member 112, electrical leakage and the like due to water infiltration is prevented. Note that the cover member 112 is attached to the base frame 16 in a state where a first wire harness 116 and a second wire harness 118 (described later) are connected to the first input bolt 74 and the second input bolt 78.

### Connection to Vehicle

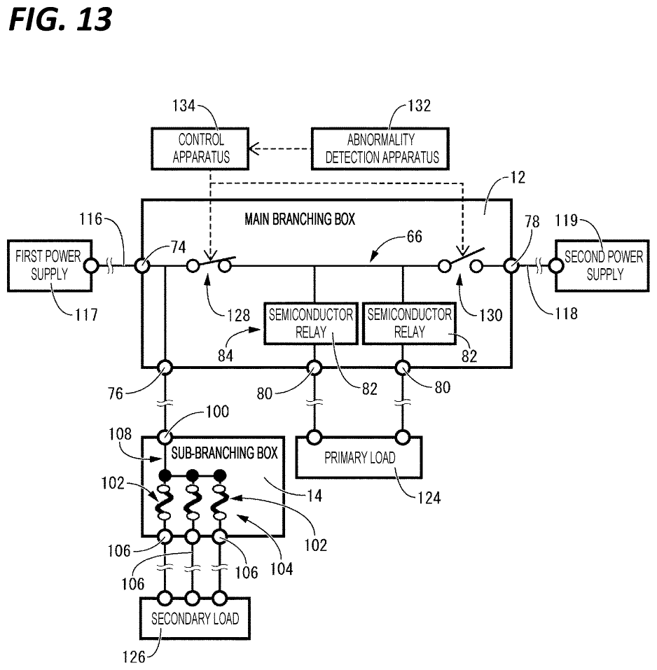

The power distribution unit 10 constructed as described above is disposed for example in the engine compartment of a vehicle. When the power distribution unit 10 has been installed in a vehicle, the first input bolt 74 of the main branching box 12 is connected via a first wire harness 116 to the first power supply 117, and the second input bolt 78 is connected via a second wire harness 118 to a second power supply 119 (see FIG. 13). With this configuration, power is supplied to the main branching circuit 66, and also to the sub-branching circuit 108 via the output bolt 76 of the main branching circuit 66.

The first wire harness 116 and the second wire harness 118 each have a structure in which a crimped terminal 122 is crimped onto the front end of a covered electric wire 120. The crimped terminals 122 are attached to the first input bolt 74 and the second input bolt 78 in an externally inserted state and electrically connect the first and second wire harnesses 116, 118 to the first and second input bolts 74, 78. The first and second wire harnesses 116, 118 are bent into L-shapes at the ends of the crimped terminals 122 that extend upward, and are routed in the routing areas 110, 110 formed above both front and rear end parts of the upper plate portion 24 of the base frame 16. By doing so, the sub-branching box 14, which is disposed in a center part in the front-rear direction of the upper plate portion 24, is positioned between the first and second wire harnesses 116, 118, and the first and second wire harnesses 116, 118 are positioned outside the sub-branching box 14 on the front and rear sides, which means that the first and second wire harnesses 116, 118 are routed in space-saving manner. As a result, the space required for placing the power distribution unit 10 and the first and second wire harnesses 116, 118 can be reduced.

A primary load 124 is connected to connectors 80 of the main branching circuit 66 (see FIG. 13), and power distributed in the main branching circuit 66 is supplied to the primary load 124. The primary load 124 is a load with a function that relates to the running safety of the vehicle, such as a driving control system, a braking system, or a steering system. On the other hand, a secondary load 126 is connected to the sub-branching circuit 108 (see FIG. 13), and power distributed in the sub-branching circuit 108 is supplied to the secondary load 126. The secondary load 126 is a load with a function that relates to comfort in the vehicle, such as an air conditioning apparatus or an audio apparatus.

The main circuit protection unit 84 of the main branching circuit 66 is configured using semiconductor relays 82, and is therefore less susceptible to failure compared to the sub-circuit protection unit 104 which is constructed of the mechanical fuses 102. This means that connecting the primary loads 124 to the main branching circuit 66 improves the running safety of the vehicle. Additionally, by using the semiconductor relays 82 that are less likely to fail, the location where the main branching box 12 is placed is less susceptible to being restricted by considerations relating to replacement tasks compared to when mechanical fuses are used, resulting in greater freedom in selecting the space in which the main branching box 12 is disposed.

On the other hand, the sub-circuit protection unit 104 of the sub-branching circuit 108, to which primary loads 124 relating to comfort in the vehicle are connected, is constructed of mechanical fuses 102, which makes it possible to reduce the physical size and cost of the power distribution unit 10 compared to when the main circuit protection unit 84 and the sub-circuit protection unit 104 are entirely constructed of semiconductor relays.

As shown in FIG. 13, the main branching circuit 66 on the printed circuit board 68 is provided with a first semiconductor switch 128 that switches a power supplying path from the first power supply 117 between conductive and cutoff states, and a second semiconductor switch 130 that switches a power supplying path from the second power supply 119 between conductive and cutoff states. In the normal state shown in FIG. 13, the first semiconductor switch 128 is ON and the second semiconductor switch 130 is OFF. Accordingly, in the normal state, power from the first power supply 117 is supplied to the main branching circuit 66 and the sub-branching circuit 108, and power from the second power supply 119 is cut off by the second semiconductor switch 130 and is not supplied to the main branching circuit 66 or the sub-branching circuit 108.

A known abnormality detection apparatus 132 that monitors the current flowing through the main branching circuit 66 is provided separately from the power distribution unit 10. If the abnormality detection apparatus 132 has detected an abnormality, such as a stoppage of the supplying of power from the first power supply 117 to the main branching circuit 66, the abnormality detection apparatus 132 transmits an abnormality detection signal to a control apparatus 134. The control apparatus 134 is an apparatus that performs ON/OFF switching control of the first and second semiconductor switches 128, 130, and if an abnormality detection signal has been received from the abnormality detection apparatus 132, the control apparatus 134 transmits a switching instruction signal to the first and second semiconductor switches 128, 130. The switching instruction signal switches the first semiconductor switch 128 OFF and switches the second semiconductor switch 130 ON. As a result, the supplying of power from the first power supply 117 is stopped, and power from the second power supply 119 is supplied via the main branching circuit 66 to the primary load 124. If an abnormality has been detected, power is supplied from the second power supply 119 to the main branching circuit 66 only and power is no longer supplied to the sub-branching circuit 108. However, because the sub-branching circuit 108 distributes power to the secondary load 126 that relates to vehicle comfort, the running safety of the vehicle will be maintained even if the supplying of power to the sub-branching circuit 108 is lost.

In this way, the main branching circuit 66 that distributes power to the primary loads 124 that relate to the safety of the vehicle is connected to two power supplies and is configured to be selectively supplied with power from these power supplies. This means that even if one power supply is lost, the functioning of the primary loads 124 can be maintained by supplying power from the other power supply, which means that the safety of the vehicle can be maintained more reliably. In particular, with the present embodiment, if the first power supply 117 is lost, the supplying of power to the sub-branching circuit 108 connected to the secondary loads 126 is cut off by the first semiconductor switch 128, which ensures a stable supplying of power to the primary loads 124 using just the second power supply 119 which is provided as an auxiliary power supply.

Note that at least one of the abnormality detection apparatus 132 and the control apparatus 134 may be configured as a chip mounted on the printed circuit board 68 and provided inside the main branching box 12.

### Modifications

Although an embodiment of the present disclosure has been described above as a specific example, the present disclosure is not limited to this specific description given above. Modifications, improvements, and the like that achieve the object of the present disclosure are also included in the present disclosure. As examples, the following modifications to the embodiments are also included within the technical scope of the present disclosure.
(1) Although an example where the main branching box 12 and the sub-branching box 14 are provided adjacent to each other has been described in the first embodiment, as another example the main branching box 12 and the sub-branching box 14 may also be provided at positions that are distant from each other. In this case, the main branching circuit 66 of the main branching box 12 and the sub-branching circuit 108 of the sub-branching box 14 are electrically connected to each other by a wire harness, for example. With this configuration, it is possible to achieve a great degree of freedom in the placement of the main branching box 12 equipped with a main circuit protection unit 84 that is less susceptible to failure through the use of the semiconductor relays 82, and also easy to dispose the sub-branching box 14, which is equipped with the sub-circuit protection unit 104 that uses the mechanical fuses 102 which require replacement, in a location where replacement is easy.
(2) Although a structure in which one sub-branching box 14 is connected to one main branching box 12 is described as an example in the first embodiment, it is also possible to connect a plurality of sub-branching boxes 14 to one main branching box 12, and to arrange the plurality of sub-branching boxes 14 in a distributed manner.
(3) In addition to the first power supply input portion and the second power supply input portion, the main branching box may also be provided with an additional power supply input portion that receives power from a power supply aside from the first and second power supply 117 and 119. It is also possible to configure the main branching box 12 so as to receive power from only one power supply.
(4) Although a configuration where when an abnormality has occurred at the first power supply 117 and the supplying of power has switched to the second power supply 119, power is supplied only to the primary loads 124 and not to the secondary loads 126 has been described in the first embodiment, as another example, power may also be supplied from the second power supply 119 to both the primary loads 124 and the secondary loads 126. With this configuration, the vehicle can maintain a state that is substantially identical to the normal state where power is supplied from the first power supply 117 even when the supplying of power is switched to the second power supply 119.
(5) Although the primary loads 124 and the secondary loads 126 are divided into loads relating to vehicle safety and loads relating to other aspects, such as comfort, in the first embodiment, the primary loads 124 are loads supplied with power from a main output portion, and the secondary loads 126 are loads supplied with power from a sub-output portion, and the loads do not need to be classified in the same way as in the embodiment described above. As a specific example, even if a load relates to comfort in the vehicle or the like, when the functions of such load need to be maintained with high reliability, the load may be included as one of the primary loads 124.
(6) When it is not essential to seal the inside of the base frame 16 with the filler 96, as one example, if the main branching box 12 is disposed in a location that will not get wet, the filler 96 may be omitted. The cover member 112, which is provided for purposes such as waterproofing and dustproofing, is also not essential and can also be omitted.

### LIST OF REFERENCE NUMERALS

10 Power distribution unit (First embodiment)
12 Main branching box
14 Sub-branching box
16 Base frame
18 Heat dissipating plate
20 Peripheral wall portion
22 Bottom plate portion
24 Upper plate portion
26 First side wall
28 Terminal insertion hole
30 Second side wall
32 Connector insertion hole
33 Contact surface
34 Through window
36 Outer periphery support portion
38 Center support portion
40 Annular protrusion
42 Center protrusion
44 Leg portion
46 Bolt hole
48 Engagement protrusion
50 Guide portion
52 Positioning piece
54 Insertion portion
56 Contact plate portion
58 Heat dissipating fin
60 Board contact portion
62 Annular channel
64 Center channel
66 Main branching circuit
68 Printed circuit board
70 First bus bar
72 Second bus bar
74 First input bolt (First power supply input portion)
76 Output bolt (Main output portion)
78 Second input bolt (Second power supply input portion)
80 Connector (Main output portion)
82 Semiconductor relay
84 Main circuit protection unit
85 Jump bus bar
86 Field-effect transistor
87 Hood
88 Connector plate portion
90 Fixing portion
92 Connector unit
94 Electrically-insulating thermally-conductive member
96 Filler
98 Subframe
100 Bus bar (Sub-input portion)
102 Mechanical fuse
104 Sub-circuit protection unit
106 Output wire (Sub-output portion)
108 Sub-branching circuit
109 Fuse placement portion
110 Routing area
112 Cover member
114 Engagement portion
116 First wire harness
117 First power supply
118 Second wire harness
119 Second power supply
120 Covered electric wire
122 Crimp terminal
124 Primary load
126 Secondary load
128 First semiconductor switch
130 Second semiconductor switch
132 Abnormality detection apparatus
134 Control apparatus

1. A power distribution unit comprising:
a main branching box; and
a sub-branching box,
wherein the main branching box includes a first power supply input portion, a plurality of main output portions, and a main branching circuit that branches power inputted into the first power supply input portion to the plurality of main output portions,
the sub-branching box includes a sub-input portion connected to one of the plurality of main output portions, a plurality of sub-output portions, and a sub-branching circuit that branches power inputted into the sub-input portion to the plurality of sub-output portions;
the main branching circuit includes a main circuit protection unit, which is constructed by a semiconductor relay mounted on a printed circuit board and prevents an overcurrent from flowing into the main output portions aside from the main output portion to which the sub-input portion is connected, and
the sub-branching circuit includes a sub-circuit protection unit constructed by a mechanical fuse that prevents an overcurrent from flowing into the sub-output portions.

2. The power distribution unit according to claim 1,
wherein the main branching box includes a second power supply input portion to which a second power supply, which differs from the first power supply connected to the first power supply input portion, is connected,
the main branching circuit includes semiconductor switches that are mounted on the printed circuit board and separately connect the first power supply input portion and the second power supply input portion to a circuit on the main output portion side, and
when an abnormality occurs for one out of the first power supply and the second power supply, the first power supply input portion or the second power supply input portion connected to another out of the first power supply or the second power supply is connected by the semiconductor switches to the circuit on the main output portion side.

3. The power distribution unit according to claim 2,
wherein the main branching box includes a heat dissipating plate which is in thermal contact, via an electrically-insulating thermally-conductive member, with an opposite surface of the printed circuit board to a surface on which the semiconductor relay is mounted.

4. The power distribution unit according to claim 3,
wherein the main branching box includes a base frame including a bottom plate portion on which the printed circuit board is placed, and a peripheral wall portion that protrudes from a peripheral edge of the bottom plate portion and surrounds a periphery of the printed circuit board,
an opposite surface of the bottom plate portion of the base frame to the surface on which the printed circuit board is placed forms a contact surface that contacts the heat dissipating plate,
the bottom plate portion includes an outer periphery support portion, which extends continuously around a circumference of the printed circuit board and on which a peripheral edge of the printed circuit board is placed, and a through window, which passes in the plate thickness direction through an area closer to an inside than the outer periphery support portion,
the contact surface of the outer periphery support portion is provided with an annular protrusion that protrudes toward the heat dissipating plate and extends continuously around a circumference of the outer periphery support portion,
a surface of the heat dissipating plate that faces the base frame is provided with an annular channel, which is recessed in an annular shape and into which the annular protrusion is inserted, and
in a state where the bottom plate portion of the base frame has been placed on the heat dissipating plate, the annular protrusion has been inserted into the annular channel, and the opposite surface of the printed circuit board exposed through the through window has contacted the heat dissipating plate via the electrically-insulating thermally-conductive member, an internal region of the base frame surrounded by the peripheral wall portion and the bottom plate portion is filled with a resin material.

5. The power distribution unit according to claim 4,
wherein the bottom plate portion includes a plurality of the through-windows that are spaced apart, and parts of the bottom plate portion remaining between the through-windows connect facing edge portions of the outer periphery support portion to form a center support portion on which a center part of the printed circuit board is placed,
the contact surface of the center support portion has a center protrusion that protrudes toward the heat dissipating plate, and
the center protrusion is inserted into a center channel formed as an opening at a position on a base frame-side surface of the heat dissipating plate that faces the center protrusion.

6. The power distribution unit according to claim 4,
wherein the base frame is positioned facing the bottom plate portion with a gap in between and is shaped as a rectangular box including an upper plate portion that covers an opening at a protruding end of the peripheral wall portion,
the first power supply input portion and the second power supply input portion, which are bolt-shaped, are provided at both ends in a width direction of a first side wall that constructs the peripheral wall portion,
both end regions in a width direction of the upper plate portion adjacent to the first side wall form a pair of routing regions in which wire harnesses, on which crimped terminals fastened to the first power supply input portion and the second power supply input portion have been crimped, are routed, and the sub-branching box is positioned in a center part in the width direction of the upper plate portion between the pair of routing regions.
